(19) United States
(12) Patent Application Publication
(10) Pub. No.: US 2009/0300348 A1
(43) Pub. Date: Dec. 3, 2009

(54) PREVENTING ABUSE OF SERVICES IN TRUSTED COMPUTING ENVIRONMENTS

(75) Inventors: Onur Aciicmez, San Jose, CA (US); Xinwen Zhang, San Jose, CA (US); Jean-Pierre Seifert, San Jose, CA (US)

Correspondence Address: Beyer Law Group LLP, P.O. BOX 1687, Cupertino, CA, 95015-1687, US

(73) Assignee: SAMSUNG ELECTRONICS CO., LTD., Suwon City (KR)

(21) Appl. No.: 12/131,711

(22) Filed: Jun. 2, 2008

(51) Int. Cl. H04L 9/06

(52) U.S. Cl. 713/156

(57) ABSTRACT

Methods and systems for regulating services provided by a first computing entity, such as a server, to a second computing entity, such as a client are described. A first entity receives a request for a service from a second entity over a network. The first entity determines whether the second entity has a trusted agent by examining an attestation report from the second entity. The first entity transmits a message to the second entity. The trusted agent on the second entity may receive the message. A response is created at the second computing entity and received at the first entity. The first entity then provides the service to the second entity. The first entity may transmit an attestation challenge to the second entity and in response receives an attestation report from the second entity.

### BACKGROUND OF THE INVENTION

1. Field of the Invention

The present invention relates to computer networks and trusted computing environments. More specifically, it relates to leveraging components and processes in a trusted computing environment to regulate the use of services made available by a computer system, thereby achieving the objectives of, for example, conventional cryptographic puzzles.

2. Description of the Related Art

As computer networks become increasingly prevalent in nearly all circles of commerce, government, education, and public sectors, attempted abuse of services from certain types of server computers in these networks will continue to be a threat and concern to those who operate and use the networks. In the past and even in today's computing environment, threats such as Denial-of-Service (DoS), annoyances such as SPAM, and other evolving techniques to abuse services of a computing device need to be dealt with in creative ways.

One conventional method used to deal with abusive practices targeting servers is the use of cryptographic puzzles (CPs), sometimes also referred to as client puzzles. These puzzles are computational problems typically given to a computer system, such as a PC, to introduce a computational cost to the PC when it requests a service from another computer system, such as a server. In a simple illustration, a PC requests a service from a server computer on a network, first by establishing a connection to that server. Before the server will allow the connection, it may require the PC to solve a CP, essentially a mathematical puzzle, and return the solution or answer to the server. If it receives a correct solution, the server allows the connection and provides the requested service. In this manner, there is a negligible computational cost to the PC to ensure that it is not attempting to abuse the server. This negligible cost can be significant cost (i.e., processing total time required to solve a multitude of CPs) to those PCs that try to bring a server down or otherwise cause harm. This essentially slows the attacker down to the point where abusing the server by repeatedly asking for a service is no longer beneficial.

Some of the drawbacks of CPs include the additional computational costs to a small or low-resource computing device in having to solve the puzzles and which is not attempting to abuse a service. Furthermore, the real time cost of a CP is difficult to measure and may vary widely depending on the type of device executing the puzzle. Another drawback is that a device having only one CPU can only solve one CP at a time but may have several CPs that it needs to compute for legitimate service requests.

A paradigm that is becoming increasingly prevalent in computer systems and devices is the trusted computing environment. Many desktop computers, laptops, notebook computers, and other widely used devices are beginning to employ trusted computing components to ensure predictable, reliable, and trusted behavior. It would be desirable to use these trusted computing components and techniques, already present and being performed by many devices, for preventing abuse of services from computer systems, thereby achieving the same objectives of conventional cryptographic puzzles.

### SUMMARY OF THE INVENTION

One aspect of the present invention is a method of regulating services provided by a first computing entity, such as a server, to a second computing entity, such as a client. The first entity receives a request for a service from the second entity over a network. The first entity determines whether the second entity has a trusted agent by examining an attestation report from the second entity. The first entity transmits a message to the second entity. In one embodiment, the trusted agent on the second entity may receive the message. A response is created at the second computing entity and received at the first entity. The first entity then provides the service to the second entity. In one embodiment, the first entity transmits an attestation challenge to the second entity and in response receives an attestation report from the second entity.

Another embodiment of a method of regulating services provided by a first computing entity to a second computing entity includes, at the first computing entity, receiving a request for a service from the second computing entity. A message is transmitted to the second computing entity from the first entity containing a security requirement of the requested service and a cryptographic puzzle. The first entity receives a response from the second computing entity, where the response is either a cryptographic puzzle solution or a data package including a verification obtained by a trusted agent that the requested service complies with the security requirement. The first computing entity provides the service to the second entity. In one embodiment, the trusted agent may enforce the security requirement on the second computing entity. In another embodiment, the second computing entity may initiate a remote attestation without receiving an attestation challenge from the first computing entity.

In another aspect of the present invention, a network for regulating services comprises two nodes. A first node includes a first trusted platform module (TPM), is a trusted computing environment and is able to provide a service. It has a security policy that regulates access to the service. A second node includes a second TPM and a trusted agent, where the second node is a trusted computing environment and the trusted agent enforces the security policy of the first node. The security policy is communicated from the first node to the agent and the trusted agent transmits a verification to the first node when providing the service to the second node complies with the security policy.

The methods of the present invention may be implemented, at least in part, by hardware and/or software. For example, some embodiments of the invention provide computer programs embodied in machine-readable media. The computer programs include instructions for controlling one or more devices to perform the methods described herein.

### BRIEF DESCRIPTION OF THE DRAWINGS

References are made to the accompanying drawings, which form a part of the description and in which are shown, by way of illustration, particular embodiments:

FIG. 1 is a simplified logical block diagram of two computing systems having trusted computing components that may be used in one implementation of the present invention;

FIG. 2A is a flow diagram of one method of using a trusted agent to enforce a security requirement of a server on a client requesting a service from the server in accordance with one embodiment of the present invention

FIG. 2B is a flow diagram of another process of regulating services provided by a server to a client in accordance with another embodiment of the present invention;

FIG. 3 is a block diagram showing examples of data that may be stored in a trusted agent in accordance with one embodiment of the present invention; and

FIG. 4 is a flow diagram of a process of a server using remote attestation to identify a client and keep track of services being requested by the client.

### DETAILED DESCRIPTION OF SPECIFIC EMBODIMENTS

Reference will now be made in detail to specific embodiments of the invention including the best modes contemplated by the inventors for implementing the invention. Examples of these specific embodiments are illustrated in the accompanying drawings. While the invention is described in conjunction with these specific embodiments, it will be understood that these embodiments are not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order to not unnecessarily obscure the invention.

Methods and systems for preventing malicious, abusive, or excessive use of services provided by a computing system to another computing system, where both operate on trusted computing platforms, are described in the various figures. In one embodiment, the computer system providing a service, referred to herein as a server, but may be any type of computing device, e.g., a mobile handset device, capable of providing a service in a network, is able to control its own security and regulate access to its services as needed or desired by other computing systems in the network. These other computing systems are referred to herein as clients, and may also be one or more of numerous types of computing devices. In the present invention, the server uses trusted computing components and properties to control security and access to its services. As described above, a conventional server may regulate external use of its services by employing cryptographic (or client) puzzles and other techniques.

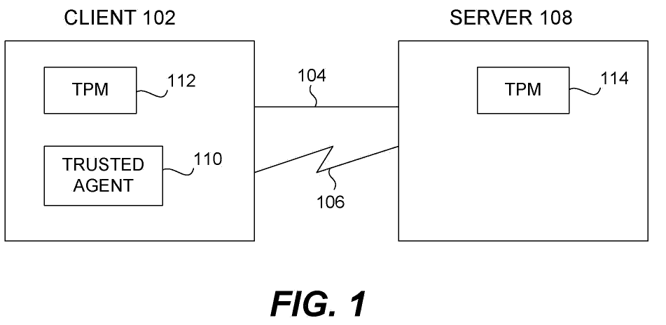

FIG. 1 is a simplified logical block diagram of two computing systems that may be used in one implementation of the present invention. At least one of the computing systems operates on a trusted computing platform. For illustrative purposes and as shown in FIG. 1, both computing systems operate in trusted environments, as described below. Before describing details of various embodiments of the present invention and how trusted computing concepts and components are leveraged to achieve system security and control, a brief description of relevant trusted computing concepts is provided.

Although still an evolving technology, trusted computing has reached a stage of maturity where it is now viewed as commercially viable by many computer and chip manufacturers. As a result, it may now be found in numerous consumer computing products, especially desktop computers, laptop computers, servers, and smaller mobile computing devices. A computing device or system having a trusted computing platform is expected to operate in a highly predictable manner; that is, the device will execute or do what a user expects it to do (what is expected of it can, of course, vary widely and may in fact be something harmful or malicious). Information on trusted computing can be found at many sources such as at the Trusted Computing Group (TCG) Web site, which provides definitions of services which provide a base for TCG's implementation and standards for trusted computing. As discussed below, protocols and messages may be added which take advantage of established trusted computing concepts.

Returning now to FIG. 1, a client computing device 102 has a wired 104 or wireless 106 connection with a server computer 108. Wired and wireless connections may implement any appropriate type of network through which the two devices may establish a connection for data transmission, such as the Internet, a VPN, Intranet, or any privately operated network.

Although trusted computing concepts generally encompass numerous features and involve various processes and components, those that are particularly relevant to embodiments of the present invention include—using terms from the TCG—Trusted Platform Module (TPM), trusted agents, and a process known (in TCG and more generally) as remote attestation. Using these concepts and components, among others, a trusted computing platform on a computer system provides security guarantees to standard computing architectures which would otherwise be conventionally achieved using, for example, secure co-processors. Trusted computing allows for security guarantees in an open computing device that are similar to those conventionally available only in closed computing devices.

One key feature of trusted computing is the ability to perform remote attestation. This technique allows a device (e.g. a client computer) to certify to a remote entity (e.g., a server) that the client is running a known combination or configuration of hardware and software, and that such software and hardware have not been tampered with. Using another process referred to as process isolation, trusted computing can guarantee that a trusted agent (a type of secure process in a trusted computing environment) is protected from inspection or modification by other agents or processes. Remote attestation combines the assurance that a trusted computing environment is running and that the remote party (e.g., the server) is communicating with a trusted agent having particular properties in the trusted environment.

Central to a trusted computing implementation is a trusted module or TPM which may be described as a processor (similar to a hardware cryptographic processor) that has protected storage. A TPM guarantees trusted execution for a set of software components. The TPM is essentially a hardware security anchor in a computing device and is capable of performing standard public-key encryption/signing, symmetric-key encryption, and hashing. It is also capable of generating and storing private keys such that they cannot be retrieved by software means. Finally, a TPM enables “measurements” of a computing system state to be stored securely inside it and used in reports or “quotes” needed for remote attestation, as described in greater detail below.

Remote attestation is a process that creates an attestation report that is stored, for example, in the secure storage areas of the TPM. Attestation may be described as a process in which security checks are passed on from one process or layer in the computing system to the next, such that trust is extended in layers. At each layer or process, a “measurement” is stored in secure registers in the TPM. These measurements collectively comprise an attestation report of the computing system. During remote attestation, the remote entity requesting attestation of a device receives the device's attestation report (or, when hashed or signed by the TPM in the device, may be referred to as a “quote”).

The process of creating a report begins with taking a first measurement which is done by the TPM, a security anchor and the primary trusted component in the device. When a computing system is powered on or “booted up,” the TPM chip is the first component in the system to begin operations (immediately after the power supply components provide power to the system) and takes control right away. The TPM begins by taking the first measurement. In one example, it uses software embedded in its registers to take the measurement of the Basic Input/Output System or BIOS. After taking a measurement of the BIOS and storing the measurement (the TPM may also calculate a hash value of the measurement using a TPM certificate before storing the measurement), the TPM compares the hash value (e.g., an SHA-1 or MD5 hash) to a hash value it had previously stored of a trusted BIOS or is stored somewhere on the network that is secure and accessible by the TPM. If the values do not match, the process ends and the device may not boot up or only be operable in a non-trustworthy state. If the values match, the TPM extends or passes the responsibility of taking the next measurement to the BIOS. At this stage the TPM trusts the BIOS and is willing to pass on this trust by allowing the BIOS to perform the next security check.

The BIOS has the necessary software to perform a measurement and will use this software to take a measurement, for example, of the system bootloader. The TPM provides the BIOS (and each subsequent component) with a secure and protected work area and registers (e.g., Platform Configuration Registers or PCRs) to store data needed to calculate measurement values. Thus, although the task of taking the measurement is passed on, the TPM still plays an important role by providing secure storage areas and known hash values of trusted processes and components to which subsequent measurements will be compared.

After the BIOS has taken a measurement of the bootloader and hashes it, the hashed value is compared to a known hash value of a trusted bootloader (stored either in the TPM or in a suitable area in the network). If they match, the BIOS passes trust to the bootloader, which has the necessary software to take a measurement of the next component in the boot up process, typically the operating system (or O/S kernel). The same or similar process occurs at the O/S level and may continue until a suitable outer layer has been reached, such as an application layer or when there is a set of measurements that ensure the integrity of software and hardware in the client. An attestation report is typically a subset of all the hash values of all the measurements stored by the TPM and may be signed using the TPM certificate (a private key in the certificate) before it is transmitted to the remote entity (i.e., server) to ensure the genuineness of the TPM.

As noted earlier, the present invention focuses on a trusted agent 110 residing on the client 102 for enforcing security policies of services. The agent may reside in various places, such as in the operating system or as a stand-alone process. First, a trusted computing environment is established using the trusted boot process described above with respect to attestation (in which each component in the boot sequence, starting from TPM 112, attests to the next component or process before handing over control.

In a preferred embodiment of the present invention, client 102 requesting service 108 from a server is required by server 108 to have trusted agent 110. In one embodiment, only client 102 operates on a trusted computing platform and has a TPM and server 108 may operate on a platform that is not a trusted computing platform or environment and thus does not have a TPM or other trusted computing elements and components. In another embodiment, both client 102 and server 108 operate in a trusted computing environment. Server 108 does not have to operate on a trusted platform in order to make an attestation challenge or examine attestation reports. The primary goal of trusted agent 110 (provided by TPM 114 on server 108) is to assist server 108 in enforcing one or more security policies intended to prevent abuse of its services. Of course, there may be a wide range of policies used to meet various security objectives and any suitable type of trusted agent may be used. In this embodiment, and as discussed in more detail below, there may be a standard protocol used for communications between agent 110 and server 108.

In an alternative embodiment of the present invention, server 108 providing a service to client 102 may first require attestation from the client (again, both systems are assumed to be trusted devices). Thus, each time client 102 requests a service, remote attestation is performed between server 108 and client 102 over network connections 104 and 106, thereby providing server 108 with a unique identifier of client 102. Specifically, what is provided is a unique identifier of TPM 112 utilized in client device 102. With this information, server 108 can keep track of clients and their requests and deny services to clients it has determined are abusing its services.

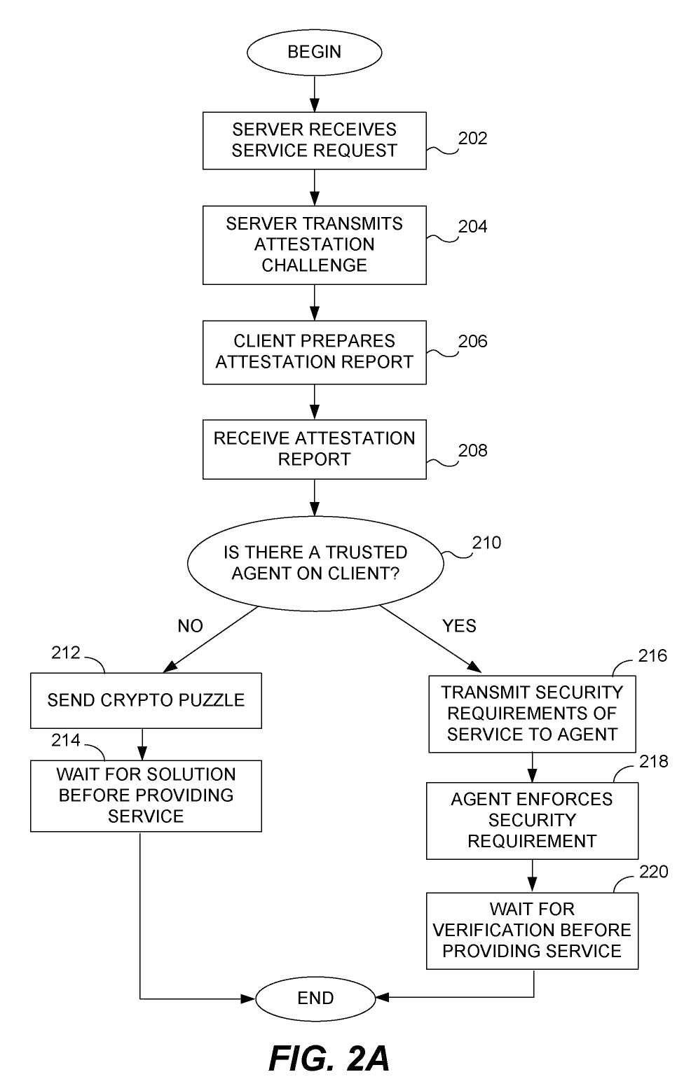

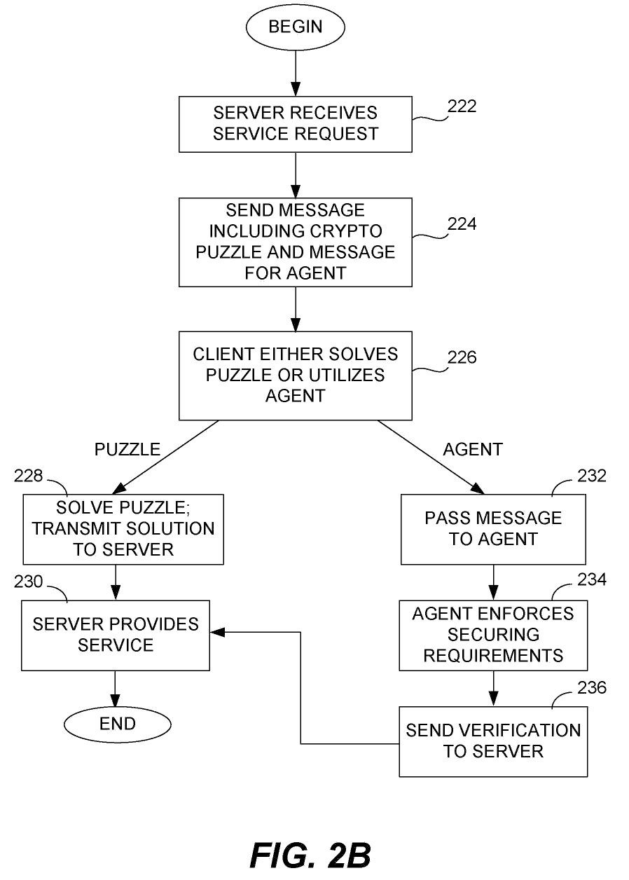

FIG. 2A is a flow diagram of one method of using a trusted agent to enforce a security requirement of a server on a client requesting a service from the server in accordance with one embodiment of the present invention. The order of the steps provided in the flow diagram of FIGS. 2A and 2B is not intended to imply a strict order of the process. Some of the steps may be done in a different order than that shown and some of the steps may not be needed in other embodiments or more steps may be needed that are not described below. At step 202 a server or other computing system offering one or more services to other systems in a network receives a request for a service from a client (second computing system). Such a request may be transmitted or communicated to the server via a wireless or wired network. In the embodiment described, both computing systems operate on trusted computing platforms. In other embodiments, only the client computing system operates on a trusted platform.

At step 204 the server, in response to receiving the service request, transmits an attestation challenge to the client. As described above, an attestation challenge requires that the receiver of the challenge to create and transmit an attestation report. The TPM to ensure authenticity to the server, and transmits the report to the server at step 206. The attestation report (typically containing a subset of hashed measurement values) may be signed using the TPM's certificate, a process sometimes referred to as quoting in trusted computing. Essentially, the server is requesting that the client send a report of its software configuration. Given that the client is a trusted computing platform in this embodiment or scenario, at step 206 the client is able to prepare an attestation report and transmit it to the server. At step 208 the server receives the report in response to the challenge it made at step 204.

At step 210 the server examines the report and determines whether the client has a specific trusted agent in its software configuration. As described above, an attestation report may be used to examine the software elements on a node operating on a trusted computing platform. If the attestation report indicates that the client does not have the required trusted agent, control goes to step 212. At step 212 the server takes the conventional route of sending a cryptographic puzzle, as described above, to the client as a means of preventing abuse and regulating access to the server's services. At step 214 the server waits for a solution or answer to the puzzle from the client before providing the service. If the server does not receive a solution, it may not provide the service.

Returning to step 210, if the server finds that the requesting client has a trusted agent, at step 216 the server transmits the security requirements of the service being requested to the agent. The types of security requirements can vary widely, have many different flavors and vary widely in complexity and objective. In a relatively simple example, a security policy or rule set may consist of a single rule such as “Fulfill the service request if the client has not requested any service from the server in the last 60 seconds” or “There must be a 10 minute period between consecutive accesses to the service.” As those skilled in the art will recognize, security requirements and policies can be quite complex and would be generally knowledgeable of the wide range of security policies that may be implemented by the server or any computing system offering services in a network (the complexity and parameters of such requirements may also depend on the hardware capabilities of the computing system). At step 218 the trusted agent enforces the security requirements. The agent has logic and software means that allows it to perform this enforcement function. From one perspective, the trusted agent may be described as now “looking out” for the interests of the server even though it resides on the client. A suitable protocol for the interaction between the server and the trusted agent within the client may be used. If a standard protocol is defined and utilized, a trusted client device may only need a single trusted agent installed and running and to be able to have numerous servers leverage the functionality of the single trusted agent by virtue of the standard protocol.

At step 220 the server provides the service to the client upon receiving a verification message from the trusted agent that the service request being made is within the parameters of the security requirements. If the server does not receive a verification from the agent, it may simply not provide the service. At this stage one cycle of the process is complete.

FIG. 2B is a flow diagram of another process of regulating services provided by a server to a client in accordance with another embodiment of the present invention. In this scenario, the client may not necessarily be operating on a trusted computing platform and this may not be known to the server. At step 222 the server receives a request for a service as in step 202 of FIG. 2A. At step 224 the server, in response to receiving the request, transmits a message or data package to the client. In one embodiment, the package may contain a conventional cryptographic puzzle and a message to a trusted agent communicating security requirements associated with the requested service. The package is intended to be received or processed initially by a trusted agent, however, the client may not be operating on a trusted computing platform and, thus, may not have a trusted agent. The server may not have knowledge of this. In this scenario, the server does not have the client's software configuration before the process initiates and does not make an attestation challenge to obtain this information.

At step 226 the client decides whether to solve the cryptographic puzzle provided by the server or, if it has a trusted agent, utilize it to obtain the service. If the client is not operating on a trusted platform or otherwise does not have a trusted agent, it will take the conventional route and solve the client puzzle. It may, for other reasons, choose to take this route even if it does have a trusted agent that it can use. At step 228 the client solves the puzzle and transmits the solution to the server. At step 230 the server, upon receiving the solution, may provide the requested service to the client.

If the client is operating on a trusted platform, it may decide to utilize a trusted agent at step 226, at which point control goes to step 232. At this step the message containing the security requirements of the server with respect to the requested service is communicated to the agent. At step 234 the agent enforces the security requirements similar to the enforcement step (218) of FIG. 2A. At step 236 the client sends a verification message to the server if the security requirements have been satisfied. The process ends at step 230 at which stage the server may provide the service to the client. An alternative embodiment of the process shown in FIG. 2B, is the server offering to download the trusted agent to the client if the client does not have one. In this embodiment, the server may offer the client an opportunity to install the agent, thereby enabling the client to obtain the service using without having to use cryptographic puzzles.

In the embodiments described herein, the server will generally want to ensure that the agent sending the verification message (as in steps 220 and 236 above) is a valid and authenticated trusted agent. One method of performing this of validation in the scenario described in FIG. 2A is by performing a remote attestation between the server and the client, where the server issues an attestation challenge, before the server establishes a communication path between the two entities. That is, the server may make an attestation challenge to the client before step 202 of FIG. 2A.

If the server and client do not perform a remote attestation, which would allow the server to check the configuration of the client before sending the package as in the scenario described in FIG. 2B, then the server may have to check the configuration of the trusted agent after getting the verification message in step 236. It is important to note that in this scenario, the server does not know, a priori, whether it will get a verification from an agent or a solution to the cryptographic puzzle (a determination that is made at step 226). Validating and authenticating the agent after getting a verification message may be done by having the trusted agent send its certificate, a certificate of the trusted platform of the client, the verification (if there is one), and an attestation report (i.e., a configuration of the client). That is, the client can self-initiate a remote attestation on its own, without a challenge from the server. By sending all the necessary information to the server, namely, the certificates, verification, and client configuration, the server can ensure the validity of the agent, as well as of the platform and configuration.

As noted above, the embodiments and scenarios described in FIGS. 2A and 2B are examples of how a trusted agent may be used by a server in a trusted computing environment to ensure that the server is not being abused. It essentially achieves one of the goals of cryptographic puzzles. Other embodiments may follow different realizations and implementations of the general concepts described above without deviating from the scope of the invention.

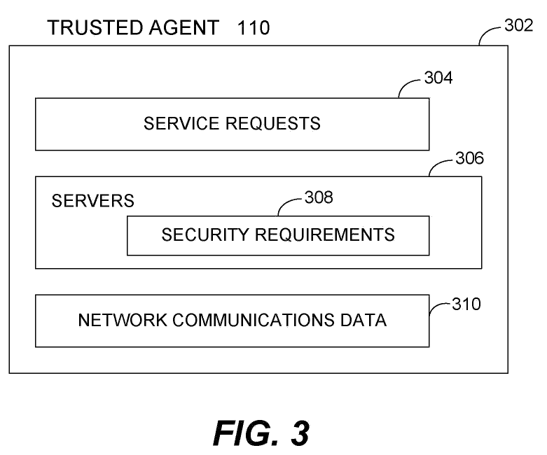

FIG. 3 is a block diagram showing examples of data that may be stored in a trusted agent in accordance with one embodiment of the present invention. As can be inferred from the flow diagrams discussed above, a trusted agent may include various types of data. Data logged or stored by trusted agent 226, if any, will likely have a direct relationship or with or be heavily dependent on the security requirements of the server, which, as noted, may vary widely and have many different flavors and characteristics. However, it would be useful to provide a few examples of data that may be stored. One example of various types of data that may be stored in an agent is shown in FIG. 3 which shows trusted agent 110 containing generally log data relating to past activity and client service requests.

One set of data may be a log 304 of the service requests made by the client or computing entity in which agent 110 operates. Another set of data 306 may be server data which may contain identification data for each or some of the servers that have utilize or have had previous communications with agent 110. Within this data or associated with it may be a data set 308 of security requirements/policies that agent 110 has received for each or some of the servers identified in server data set 306. This data may include time-related data, wait durations, and the like, as described below. Another category of data may describe or indicate whether the servers identified in log 306 support the technology of trusted agent 110. Another category may be a log of data 310 describing communications between agent 110 and the servers that support the trusted agent technology. To enable maintenance and logging of some of the data described above, such as service requests 304, server data 306, and technology support data, it may be necessary for the agent to be part of the client operating system or operate in close collaboration with it. Of course, the format of the various data described above will necessarily depend on a specific implementation of the trusted agent and other design considerations. And, as noted above, trusted agent 110 may contain some or none of these data, or entirely different types of data. The data stored will depend on the security requirements of the servers and possibly other factors. Trusted agent 110 may also contain logic to execute or enforce the security policies.

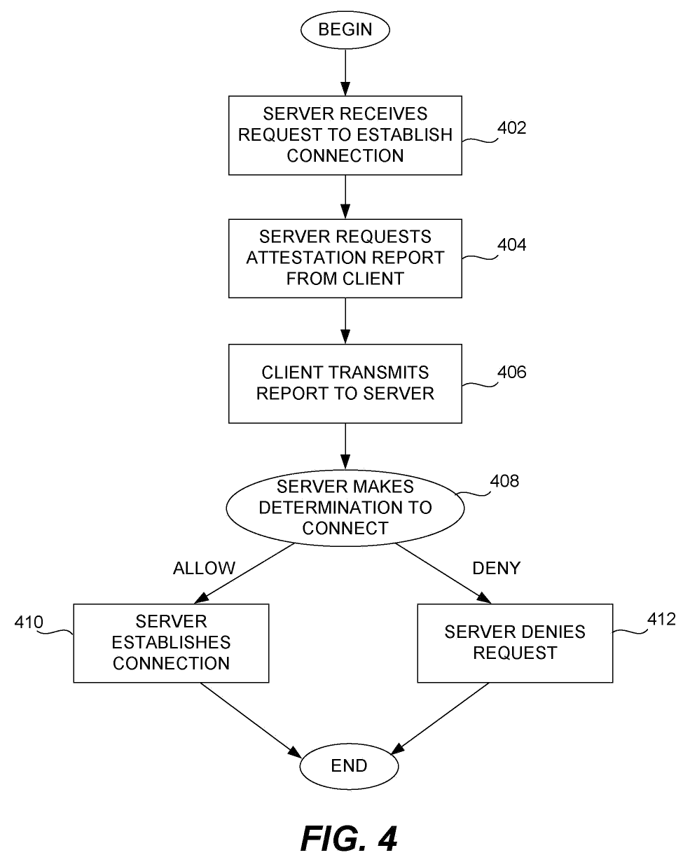

FIG. 4 is a flow diagram of an alternative methodology. It shows a process of a server using remote attestation to identify a client and keep track of services being requested by the client. As described above, remote attestation may be used between a server (the “remote” entity requesting an attestation) and client (providing the attestation) to obtain the client's software configuration or, with more advanced attestation techniques, high-level properties of the software's behavior. At step 402 the server receives a request to establish a connection from a client. In the embodiment described below, the server requires remote attestation when the client is first attempting to establish only a connection.

As noted earlier, when a server or any entity requests attestation from another entity (i.e., makes an attestation “challenge”), the requesting entity receives certain data from the device. The primary data item is the hashed representation of the device's software configuration, which may be described as a fingerprint for that device. The attestation report has hash values derived on that device by the TPM on the device. In the attestation report, a unique identifier of the TPM that is used to generate the encrypted attestation report is also provided.

At step 404, the server requests (or requires) that the client transmit an attestation report to the server. By doing so, the server can obtain a verified fingerprint of the client device. At step 406 the TPM on the client transmits the report or quote to the server. The report contains an identifier of the TPM which the server is interested in examining (the server may not be interested in the actual software configuration per se of the client). In another embodiment, the server does not request remote attestation at this stage (i.e., while establishing a connection), but does so at a later stage, as described below.

At step 408 the server determines whether the client (uniquely identified by the TPM) is entitled to have a connection established with the server. The server may make this determination by checking its data repository for a client or, more specifically, TPM identifier and the number of requests made from the client. For example, if the client identifier has a high number of requests, for example, x within a specified time frame, where x is the threshold above which the client is categorized as “abusive,” the server may not process the service request. If the server determines that it will enable a connection with the server, a connection is established at step 410. If it determines that it will not permit the request for a connection, the request is denied at step 412. At this stage the process is complete.

In another embodiment, the server allows a connection to be established at the time it receives a connection request from a client. Subsequently, when the client sends the request for a specific service to the server, the server may at that time make a remote attestation challenge to the client and follow the same procedure outlined above. The attestation report from the client would be the same fingerprint of the client's software configuration that would be provided if the attestation challenge had been requested earlier (at the time of connection).

In the alternative embodiment described, where remote attestation is used to identify the client, the server has a few additional tasks it may need to perform that it would not need to do in the preferred embodiment (utilizing a trusted agent embodying a security policy). For example, the server may have to maintain or at least have access to a data repository that stores client/TPM identifiers and corresponding data on the number of requests made by the devices, and possibly other data, such as time-related data. The server not only maintains this repository, but may also perform searches or checks on it whenever it receives an attestation report from a client. Although a search of this type may require negligible processing by the server given the relatively small volume of data, if the server receives hundreds or thousands of connection or service requests every few seconds, the cumulative processing required may be a significant burden. If the server is not a “busy” server or does not receive many service requests, naturally this additional burden with respect to processing and resources (e.g., non-volatile memory) may not be an important issue. It may also be noted that both non-anonymous and direct anonymous attestation methods may be used.

Referring now to embodiments shown in FIGS. 2A and 2B, there are many possible implementations of a protocol for communication between a server and a trusted agent (on a client) the trusted agent embodying the server's security policy. In a preferred embodiment, the server communicates with the trusted agent. The server typically prefers to communicate with a component or module it trusts on the client, namely, the trusted agent.

A sample protocol for exchanging data is described. The client initiates a connection with the server and sends a message to the server for this purpose. The server replies with a message that includes a set of rules and other data, for example, a random number (nonce), a certificate of the server, a timestamp, and a wait time duration. The nonce, wait time, and time stamp may be hashed (or signed) using the server certificate before being sent to the client.

When the client receives the message, a component within the client (e.g., a network interface) forwards the values in the message to a trusted agent in the client device. When the trusted agent receives the values, it may take the following steps. The agent may check the integrity of the values or of the message from the server. For example, it may check the legitimacy of the server (by examining the certificate) or the freshness of the message to prevent re-use of old messages by a bogus server or to prevent IS old messages from the same server (e.g., to prevent replay attacks). The agent may then hash the message and sign the nonce. It may then compute a time expiration value or “time_is_up” value by examining the current time and the wait duration time. Upon calculating the time expiration value, the agent may sleep or not operate until the amount of time indicated by the time expiration value has elapsed. The agent may then pass the original message it received from the client, together with a certificate of the agent, and a random number signed or hashed by the agent to the client. The client may then pass the original message and the additional data received from the agent to the server. Upon receiving this data from the client, the server may grant the client a connection which may enable the client to receive a service from the server.

It is understood that the above is but one example of a protocol that may be used. As one of ordinary skill in the art will recognize, there are many possible implementations of a protocol which may or may not include some of the data items described above (e.g., nonces, time stamps, time values, etc.). In the above example protocol, the agent utilizes secure storage services in the trusted platform. For example, the data related to the wait requests should be handled in a secure manner such that other software on the same trusted platform is not able to manipulate this or other related data.

The agent may also have to leverage the use of a trusted clock. That is, the clock that it depends on (if needed, as in the above example) should be protected from malicious activities or manipulation by other software in the client system. As is known in the field of trusted computing, secure storage and trusted clock concepts are well established.

In another embodiment, the trusted agent described above may receive several different requests, (e.g., multiple Wait Messages) from different servers and be able to handle them simultaneously. For example, each of the requests may mandate a different “time_is_up” value as noted above and require the agent to sleep until the lowest “time_is_up” value expires, at which time the agent serves the request associated with that time value. If an agent gets several requests from the same server, the computation of the time_is_up value for the server may be done differently. These values may be described as server centric, as opposed to client centric. Therefore, for example, if the agent gets a Wait_Duration time of x at time (y−10) from a server, and if there is already a request in progress for the server for which the time_is_up value is y, then the time_is_up value for the second (new) request will be (x+y) rather than (x+y−10).

With both embodiments described above, the process can be done in a predictable amount of time and not take excessive processing time. In addition there are no known “short cuts” to bypass the procedures. Finally, although various advantages, aspects, and embodiments of the present invention have been discussed herein with reference to various example implementations, it will be understood that the scope of the invention should not be limited by reference to such advantages, aspects, and embodiments. Rather, the scope of the invention should be determined with reference to the appended claims.

What is claimed is:

1. A method of regulating services provided by a first computing entity to a second computing entity, the method comprising:
receiving, at the first computing entity, a request for a service from the second computing entity;
determining whether a trusted agent is present on the second computing entity by examining an attestation report;
transmitting a message to the second computing entity;
receiving a response from the second computing entity; and
providing the service to the second computing entity.

2. A method as recited in claim 1 further comprising:
transmitting an attestation challenge to the second computing entity; and
receiving the attestation report from the second computing entity.

3. A method as recited in claim 2 wherein a trusted platform module (TPM) on the second computing entity prepares the attestation report and wherein the attestation report is signed by the TPM.

4. A method as recited in claim 1 further comprising transmitting a security requirement to the trusted agent if it is determined that a trusted agent is present on the second computing entity.

5. A method as recited in claim 4 wherein the response is a verification that the second computing entity has complied with the security requirement.

6. A method as recited in claim 1 further comprising transmitting a cryptographic puzzle to the second computing entity if it is determined that a trusted agent is not present on the second computing entity.

7. A method as recited in claim 6 wherein the response is a solution to the cryptographic puzzle.

8. A method as recited in claim 1 further comprising initiating a process to install the trusted agent on the second computing entity if the trusted agent is not present.

9. A method as recited in claim 1 further comprising utilizing a protocol for communication with the specific trusted agent on the second computing entity.

10. A method as recited in claim 9 wherein the protocol utilized for communication with the specific trusted agent includes transmission of a random number, a server certificate, and a timestamp.

11. A method as recited in claim 1 wherein the specific trusted agent on the second computing entity checks the integrity of the message from the first computing entity.

12. A method as recited in claim 4 wherein the trusted agent enforces the security requirement on the second computing entity.

13. A method as recited in claim 1 wherein the trusted agent stores past activity data, client service requests, and server data.

14. A method as recited in claim 1 further comprising validating the trusted agent utilizing remote attestation before establishing a communication path between the first computing entity and the second computing entity.

15. A method of regulating services provided by a first computing entity to a second computing entity, the method comprising:
at the first computing entity, receiving a request for a service from the second computing entity;
transmitting a message to the second computing entity containing a security requirement of the requested service and a cryptographic puzzle;
receiving a response from the second computing entity, wherein the response is a cryptographic puzzle solution or a data package including a verification obtained by a trusted agent that the requested service complies with the security requirement; and
providing the service to the second computing entity;

16. A method as recited in claim 15 wherein the trusted agent enforces the security requirement on the second computing entity.

17. A method as recited in claim 15 further comprising validating the trusted agent on the second computing entity.

18. A method as recited in claim 17 wherein the second computing entity initiates a remote attestation without receiving an attestation challenge from the first computing entity.

19. A method as recited in claim 17 wherein the data package further includes a trusted agent certificate and a second computing entity trusted platform certificate.

20. A method as recited in claim 19 wherein the data package further includes an attestation report containing a software configuration of the second computing entity.

21. A method of regulating services provided by a first computing entity to a second computing entity comprising:
receiving a request from the second computing entity for a service;
transmitting an attestation challenge to the second computing entity in response to the request;
receiving an attestation report from the second computing entity and examining the report for a trusted platform module (TPM) identifier of the second computing entity; and
determining whether the second computing entity is entitled to have the request fulfilled.

22. A method as recited in claim 21 further comprising checking a data repository using the TPM identifier, wherein the data repository includes time-related data.

23. A method as recited in claim 21 wherein the second computing entity creates the attestation report by hashing a plurality of values and including the TPM identifier.

24. A network for regulating services comprising:
a first node providing a service and has a security policy that regulates access to the service; and
a second node including a second node trusted platform module (TPM) and a trusted agent, wherein the second node is a trusted computing environment and wherein the trusted agent enforces the security policy of the first node;
wherein the security policy is communicated from the first node to the agent;
wherein the trusted agent transmits a verification to the first node when providing the service to the second node would comply with the security policy.

25. A system as recited in claim 24 wherein the trusted agent stores data on a plurality of first nodes, security policy data, and data on a plurality of service requests made by the second node.

26. A system as recited in claim 24 wherein an attestation report is transmitted from the second node to the first node.

27. A system as recited in claim 24 wherein the first node is a trusted computing environment and includes a first node TPM.

28. A system for regulating services comprising:
receiving, at the first computing entity, a request for a service from the second computing entity;
means for determining whether a trusted agent is present on the second computing entity by examining an attestation report;
transmitting a message to the second computing entity;
receiving a response from the second computing entity; and
providing the service to the second computing entity.

29. A system as recited in claim 28 further comprising:
means for transmitting a security requirement to the trusted agent if it is determined that a trusted agent is present on the second computing entity.

30. A system as recited in claim 28 further comprising:
means for initiating a process to install the trusted agent on the second computing entity if the trusted agent is not present.

31. A system as recited in claim 28 further comprising:
means for validating the trusted agent utilizing remote attestation before establishing a communication path between the first computing entity and the second computing entity.
